(19) United States
(12) Patent Application Publication
(10) Pub. No.: US 2026/0202651 A1
(43) Pub. Date: Jul. 16, 2026

(54) Method and System for Imaging an Elongated Bar Moving Along Its Longitudinal Axis Using a Single Imaging Device

(71) Applicant: OG Technologies, Inc., Ann Arbor, MI (US)

(72) Inventors: Tzyy-Shuh Chang, Annr Arbor, MI (US); Hsun-Hau Huang, Ann Arbor, MI (US)

(21) Appl. No.: 19/022,296

(22) Filed: Jan. 15, 2025

(51) Int. Cl. G02B 17/02; G02B 26/08; H04N 23/55

(52) U.S. Cl. CPC G02B 17/023; G02B 26/0883; H04N 23/55

(57) ABSTRACT

A system and method are provided for imaging the full surface of an elongated object moving along its longitudinal axis using a single imaging device. The system includes a linear imaging device including an imaging sensor having a plurality of pixels and a lens between the imaging sensor and the object. The lens projects radiation from different circumferential sections of a circumferential perimeter band of the object along different imaging paths onto different pixel sets of the plurality of pixels of the imaging sensor to map the entire circumferential perimeter band onto the pixels of the imaging sensor. An adjustable image reflector in an imaging path between the linear imaging device and a circumferential section of the circumferential perimeter band of the object adjusts the optical focusing of the circumferential section on a corresponding pixel set of the imaging sensor.

### BACKGROUND

### a. Technical Field

The instant disclosure relates generally to a method and system for imaging the full surface of an elongated object moving along its longitudinal axis using a single imaging device to thereby reduce the number of imaging devices required in systems of the type disclosed in prior U.S. Pat. Nos. 6,950,546, 7,324,681, 7,460,703 and 7,627,163 (“hereinafter “Existing Patents”)

### b. Background

This background description is set forth below for the purpose of providing context only. Therefore, any aspects of this background description, to the extent that it does not otherwise qualify as prior art, is neither expressly nor impliedly admitted as prior art against the instant disclosure.

It is known to produce an elongated bar or wire, metal or non-metal, by a mechanical process such as rolling, drawing or extrusion. Such a bar is different than a slab, bloom, or strip (hereafter referenced as Flats) in that the cross-section of such a bar has a smaller circumference/cross-section-area ratio such that the bar may rotate/twist about a longitudinal axis while moving forward longitudinally. The shape, when taken in cross-section, of such a bar may be a round shape, an oval shape, or a polygonal shape (hexagon, octagon or square). Bars of this type are typically referred to as “long products” rather than “flat products” in the related industries. Rolling, drawing, extrusion and the like, as used in this disclosure and hereafter referenced as a Reducing Process, describe ways for reducing the cross-sectional dimensions of a workpiece through mechanical contact between applicable tools, such as rolls and drawing dies, and the workpiece. These Reducing Processes are generally continuous, or substantially continuous, in nature.

In the manufacturing sector, the presence or absence of surface defects is a relevant criterion upon which assessments of the long products are made. For instance, surface defects account for half of the external rejects (i.e., rejected by the customer) for the steel bar and rod industry. The Existing Patents describe systems to image such long products for surface inspection. Specifically, in the Existing Patents, a minimum number of three (3) imaging devices, commonly known as cameras, is specified to cover the full circumference or perimeter of the bar for imaging the bar. The number of imaging devices, including sensors, electronics, lensing, processing capability, etc. directly impacts the cost of an imaging system. Thus, it would be advantageous and desirable to reduce the number of imaging devices.

There have been several prior disclosures documenting systems using one imaging device for imaging a cylindrical object. However, the systems as disclosed may have deficiencies in real world practices. Some conventional systems assume discrete and, at least momentarily, stationary objects. Furthermore, it is a common requirement that the objects be centered to the optical axis or that the distances from the object surface to the imaging device via different paths be kept same. These systems are inappropriate for imaging an elongated bar moving along its longitudinal axis at a relatively fast speed (e.g., in hot rolling), particularly when the bar may not be stably controlled in its lateral motion. Inventive improvements are therefore necessary to enhance the ability to handle bar variations and bar motion variations while keeping the optical arrangement simple for the ease of maintenance.

The foregoing discussion is intended only to illustrate the present field and should not be taken as a disavowal of claim scope.

### SUMMARY

In this invention, a single imaging device and one or more adjustable image reflectors are arranged in a way that enables imaging of the full circumference of an elongated bar moving along its longitudinal axis. The adjustable image reflectors are deposited into positions such that the pixels of an imaging sensor of a single imaging device are mapped to three or four different circumferential sections of a circumferential band of the elongated bar. Furthermore, the system also includes focusing mechanisms to accommodate the potential lateral movement of a moving bar.

Those skilled in the art shall know that there exist many configurations based on the aforementioned description. The present invention is applicable to bars with a variety of surface reflectivity, from mirror-like surface to dull surface, and ensures the best balance of image focusing from all viewing perspectives.

In one embodiment, a line scan camera with N pixels, i.e., the imaging device, is deposited in a position proximate an elongated bar moving along its longitudinal axis, with the linear imaging sensor of the imaging device substantially perpendicular to the bar axis. A lens is mounted on the camera such that it can focus on the bar surface and adjust the field of view of the camera to cover at least the full circumference of the targeted bar, and then be divided into X portions, with the X being 3 or 4 depending on the intended configuration. In the case X is 3, as an example and without losing generality, the center ⅓ of the N pixels will be imaging directly the bar surface that is facing the camera, defined herein as the direct view. Two image reflectors are deposited in positions for imaging the bar surface from two different perspectives, substantially 120 degrees apart from the direct view. One of the two image reflectors is deposited in a 1^{st} position at such a 1^{st} angle that will facilitate the imaging of the bar surface with the left ⅓ of the N pixels from the 1^{st} view, which is 120 degrees counter clockwise with respect to the axis of the bar from the direct view, and the other image reflector is deposited in a 2^{nd} position at such a 2^{nd} angle that will facilitate the imaging of the bar surface with the right 1/3 of the N pixels from the 2^{nd} view, which is 120 degrees clockwise with respected to the axis of the bar from the direct view. It is expected that the two image reflectors will be arranged in a symmetric manner with respect to the axis of the direct view. Those skilled in the art may question the ability to focus from all the views (direct, 1^{st} and 2^{nd}) due to the difference in working distances (i.e., the distance with which the imaging path travels from the camera/lens to the bar surface). This is critical for applications of high resolutions and/or with a large varying range in the diameter of the targeted bar. To address this issue, an image reflector in the form of an imaging path optical extender may be disposed in the imaging path of the direct view such that (1) the imaging path optical extender would not obscure the 1^{st} and 2^{nd} views, (2) the length of the imaging path of the direct view is extended to be same as that of the 1^{st} or 2^{nd} view, and (3) the imaging path of the direct view would image the same, or substantially same, surface as if the imaging path optical extender does not exist. The imaging path optical extender can be implemented by way of reflective surfaces. The foregoing description may provide the ability to adjust the focus for all the views simultaneously, but it is further desirable to be able to independently adjust the length of imaging paths for at least two views such to adjust the focus for different views independently. To accomplish this, one or more of the image reflectors may include actuators to adjust the shape or form of reflective surfaces that facilitate the 1^{st} and 2^{nd} views.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIGS. 1A-B are schematic illustrations of one embodiment of a system for imaging an elongated object extending and moving along its longitudinal axis.

FIGS. 2, 3, 4A-B and 5 are illustrations of embodiments of adjustable image reflectors for use in the system of FIGS. 1A-B and, in particular, embodiments of optical extenders.

FIG. 6 is a schematic illustration of the system of FIG. 1 illustrating use of the system to image objects having different diameters.

FIG. 7 is a schematic illustration of the system of FIG. 1 illustrating use of the system to image objects with different geometric centers.

FIG. 8 is a schematic illustration of another embodiment of an adjustable image reflector for use in the system of FIG. 1 and, in particular, a reflective surface whose position and/or shape are adjusted by an actuator.

FIG. 9 is a schematic illustration of one embodiment of a reflective surface of the adjustable image reflector of FIG. 8.

FIGS. 10-13 are schematic illustrations of embodiments of the adjustable image reflector of FIG. 8

FIGS. 14A-B are schematic illustrations of another embodiment of a system for imaging an elongated object extending and moving along its longitudinal axis.

FIG. 15 is a schematic illustration the system of FIGS. 14A-B illustrating adjustment of certain imaging paths.

### DETAILED DESCRIPTION

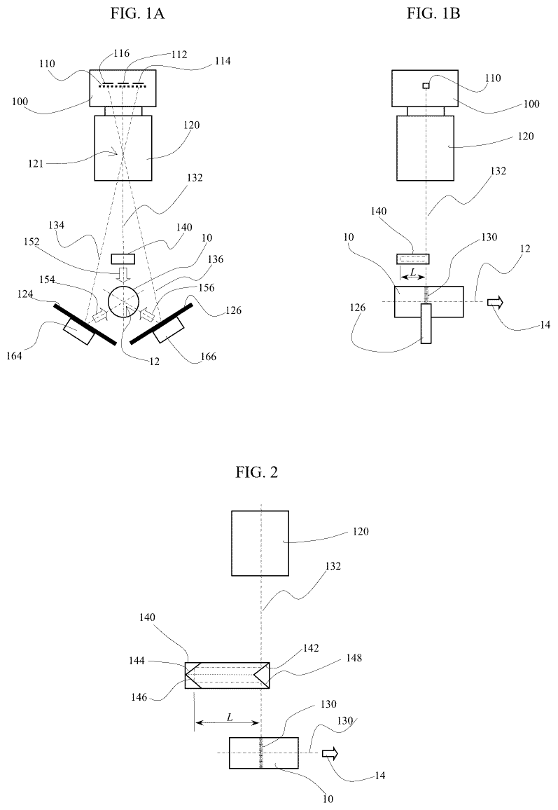

An embodiment of a system for imaging an elongated object extending and moving along its longitudinal axis is illustrated in FIGS. 1A-B for the case X=3.

A round bar 10 with its axis 12 is traveling in the direction 14. A round bar is used for the illustration purpose, but the system may be used on objects with any cross-section with a relatively symmetric convex shape, such as an oval or a polygon. The direction 14 of travel is along the bar axis 12. A linear imaging device 100, a line scan camera as illustrated, is deposited in a position suitable to image the bar surface for a portion of the bar perimeter. In this case, without losing generality, the imaging device 100 is positioned on top of the bar 10 in FIGS. 1A-B. The imaging device 100 has a linear imaging sensor 110 with N pixels. N can commonly be found in the market for 128, 512, 1024, 2048, 4096, 8192, etc. It is a widely available implementation. The linear imaging sensor 110 can be evenly divided into 3 different sets of pixels or zones, namely the center zone 112, left zone 116, and right zone 114. The objective of this invention is to map the three different sets of pixels or zones of this linear imaging sensor 110 onto different circumferential sections of a circumferential perimeter band 130 of the bar 10 from three different perspectives, preferably evenly distributed for the full imaging coverage of the perimeter band 130 of the bar 10. With this, the full surface of the bar 10 can be imaged if the line scan is coordinated with the motion of the bar 10 in the direction 14.

To accomplish the imaging of the perimeter band 130, the center zone 112 of the linear imaging sensor 110, with one third of the N pixels, is designed to be mapped to the top portion of the bar surface along an imaging path 132, which is defined as the direct view 152. The right zone 114 of the linear imaging sensor 110, with one third of the N pixels, is designed to be mapped to the lower left portion of the bar surface by the imaging path 134, which is defined as the 1^{st} view 154. Similarly, the left zone 116 of the linear sensor 110, with one third of the N pixels, is designed to be mapped to the lower right portion of the bar surface by the imaging path 136, which is defined as the 2^{nd} view 156. Ideally, the angles between two adjacent views, such as the angle between the direct view 152 and the 1^{st} view 154, shall be 120 degrees for the best practice. However, as long as the implementation accomplishes the full coverage of the circumference, minor deviation from 120 degrees and even overlapping among the views would be allowable.

A lens 120 is positioned between the bar 10 and the linear imaging sensor 110 of the imaging device 100 for focusing and projecting the light reflected or emitted from a plurality of different circumferential sections of the circumferential perimeter band 130 of the bar 10 along a plurality of different imaging paths 132, 134, 136 onto different pixel sets or zones 112, 114, 110, respectively, of linear imaging sensor 110 so as to map an entirety of the circumferential perimeter band 130 onto the plurality of pixels of the linear imaging sensor 110. The lens 120 is typically designed with an effective focal point 121, which would typically reverse the left-right direction when projecting the light from the bar surface to the linear imaging sensor 110. The design of lens 120 shall be based on the field of view coverage, to ensure enough coverage for the full perimeter band 130 with the desired image pixel resolution. Accordingly, the lens 120 establishes a field of view for the imaging device 100 greater than the circumference of the bar 10. Those skilled in the art shall have the knowledge to accomplish this lens selection.

In order for imaging paths 134 and 136 to point to the surface of the bar 10, two image reflectors 124 and 126, respectively, are adopted. The image reflectors 124 and 126 shall be large enough to facilitate the desired field of view. The image reflector 124 is deposited at the lower left of the bar 10 with an angle that will bend the imaging path 134 from the 1^{st} viewing angle to the imaging device 100. Specifically, the arrangement shall facilitate the field of view, through the lens 120, for imaging by the right zone 114 of the linear imaging sensor 110. Similarly, the image reflector 126 is deposited at the lower right of the bar 10 with an angle that will bend the imaging path 136 from the 2^{nd} viewing angle to the imaging device 100, and the arrangement shall facilitate the field of view, through the lens 120, for imaging by the left zone 116 of the linear imaging sensor 110.

In this implementation, those skilled in the art shall notice in the front view of FIG. 1A that the lengths of the imaging paths 134 and 136 could be substantially longer than that of the imaging path 132. While it is possible to keep the imaging paths 134 and 136 in focus simultaneously with a centered bar 10 when arranged in symmetry, the imaging path 132 may not be in focus due to the difference in working distances. To overcome this, another image reflector in the form of an optical extender 140 is positioned into the imaging path 132 between the lens 120 and the bar 10. Referring to FIG. 1B, the optical extender 140 can be designed to bend the imaging path out and in, thus extending the length of the imaging path by an amount of 2L, and direct the imaging path 132 back to the intended circumferential section of the perimeter band 130. The amount 2L can be designed to substantially match the difference in length between imaging paths 132 and 134 (or 136).

There are many different ways to implement the optical extender 140. It can be implemented with a minimum of 3 reflective surfaces, but the angles would not be orthogonal, and the extended distance would be more difficult to calculate. Worse yet, the alignment in the implementation would be critical. More reflective surfaces may be used, but may increase the complexity. A four-reflective surface implementation would seem to be the best practice. Basically, it is an implementation of two identical periscopes combined in an opposite manner. Referring now to FIG. 2, the imaging path 132 is first impinged onto a reflective surface 142 and bent sideways. Then, the reflective surface 144 bends the imaging path 132 downward, followed by the reflective surface 146 bending the imaging path 132 back toward its original path. At the end, the reflective surface 148 bends the imaging path 132 back downward toward the perimeter band 130 of the bar 10.

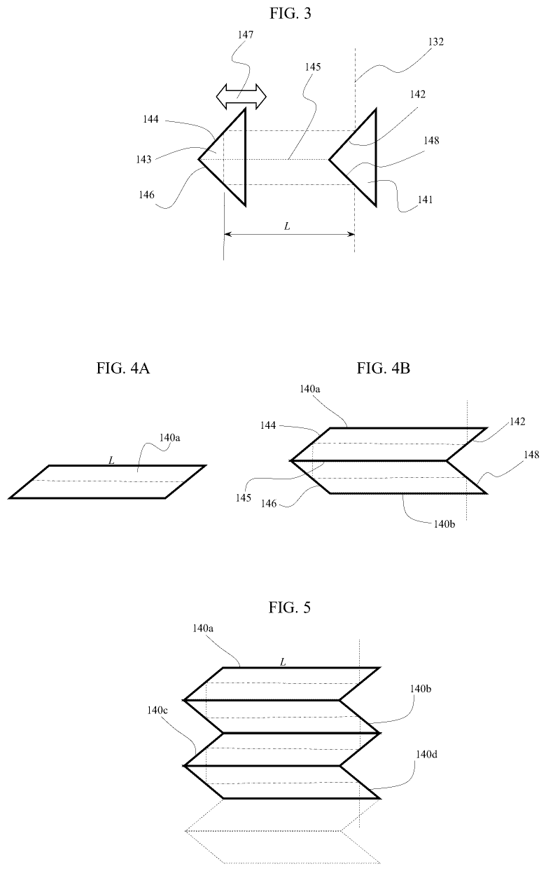

One specific embodiment of this optical extender 140 is illustrated in FIG. 3 by combining two optical prisms, one with coated reflective surfaces and the other arbitrary. The first equal length, right-angle triangular prism 141 with at least two coated reflective surfaces can be deposited between the lens 110 and the object 10, functioning as the reflective surfaces 142 and 148. The second equal length, right-angle triangular prism 143 without surface coating can be positioned in the direction where the right angle of the first prism 141 points to, and the right angles of the first and second prisms 141 and 143 aligned substantially on the same line 145, preferably perpendicular to the imaging path 132. All the surfaces of the second prism 143 shall be substantially parallel to those of the first prism 141. Note that the second prism 143 is naturally a reflector in this embodiment if the prism is made of typical translucent materials such as glass (including borosilicate glass offered for sale by Schott AG under the trademark “BK7”), quartz, polycarbonate, etc. as long as the bulk material of the prism has a refractive index higher than 1, typically at 1.3 or higher. It could even be a shell having a chamber filled with a translucent liquid such as water or oil that has a refractive index higher than 1, typically at 1.3 or higher. For this embodiment, the second prism 143 can be moved in the direction 147 such that the distance between the first and second prisms 141 and 143 can be adjusted for the change of L.

Another embodiment of this optical extender 140 is illustrated in FIGS. 4A-B by combining two identical optical prisms with opposite orientations. A parallelogram prism and, in particular, rhomboid prism, is naturally a periscope if the acute angles facilitate total reflection within the prism bulk if the light is traveling along the body axis of the prism bulk. Typically, if the acute angle is 45 degrees, it will behave the same as the second triangular prism 143 and provide total reflection within the bulk of the rhomboid prism. Combining a pair of adjacent parallelogram prisms with opposite orientations implements an optical extender. For this embodiment, the axial distance of the periscope is the length of the prism edge that is parallel to the light traveling direction. With this embodiment, it is also convenient to generate an optical extender with 2L, 4L, or 6L (even number multiples of L) extending distance by stacking the periscope pairs as illustrated in FIG. 5. It would also be possible to design a stacking of periscope pairs with different edge lengths and resulting L₁+L₂+L₃+ . . . in the total extension of the imaging path 132. The use of rhomboid prisms makes the design simple, but also keeping the entire optical train compact even for applications with the bar 10 of a large diameter.

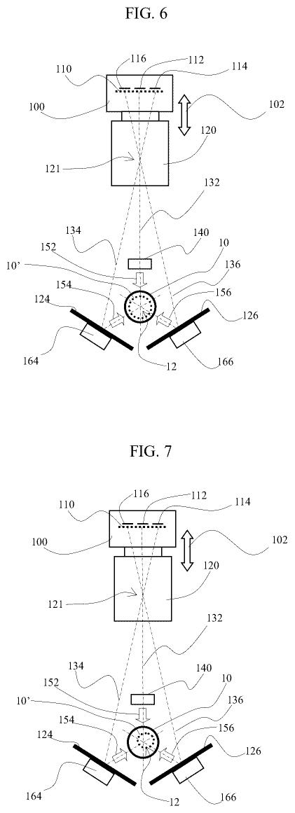

Returning to FIG. 1, those skilled in the art shall appreciate that the implementation of the image reflectors 124 and 126 shall be substantially symmetric in order to be focused by a single lens 120 and provide even coverage around the bar 10. On the other hand, as long as the lens 120 is capable of keeping both imaging paths 134 and 136 in focus, the deviation from the exact symmetry is allowable, but not quite desirable. With respect to focusing, one may further consider the case in which the diameter of the bar 10 may vary from time to time, but kept concentric. As illustrated in FIG. 6, the bar 10′, shown in dotted line, has a smaller diameter than the bar 10. In this case, the imaging paths 132, 134 and 136 all change in the same manner, all increased by one half of the diameter difference between the bars 10 and 10′. There are several approaches to re-focus when the diameter is changes. The easiest would be adjusting the lens 120. This would be the most preferable approach as the optical configuration is maintained.

One could also move the combination of the imaging device 100 and the lens 120 in the direction 102. This approach could easily be implemented, but may slightly affect the optical configuration. However, the influence may be ignorable if the diameter difference between the bars 10 and 10′ is substantially small when compared to the imaging path 132 (e.g., when the diameter difference between the bars 10 and 10′ is less than 10% of the imaging path 132). To minimize the influence on the optical configuration, the adjusting motion may even combine the optical extender 140 into the combination with the imaging device 100 and the lens 120.

Another case to consider involves not only the change in the diameter of the bar 10, but also a change in the geometric center of the bar 10 as illustrated in in FIG. 7. In FIG. 7, the bar 10′ is smaller in diameter than bar 10 and the geometric center of bar 10′ is also off-centered relative to the geometric center of bar 10 and the optical configuration used to image the surface of bar 10. Changes in the geometric center of bars 10, 10′ that are being imaged are quite common in applications where bars 10, 10′ of different sizes or shapes are imaged and where the motion of a bar 10 or 10′ cannot be precisely controlled during manufacture. Examples of such applications would be hot rolling, in which the hot steel bars are not fully constrained when the hot bars moving along their longitudinal axes. In this case, the only viable solution is to adjust focus independently for views 152,154 and 156, respectively.

In this generic case, adjusting the lens 120, or moving the combination of the imaging device 100 and the lens 120 in the direction 102, or moving the combination of the imaging device 100, the lens 120 and optical extender 140 in the direction 102 is only effective for the direct view 152. For the other views 154, 156, the focus may be adjusted by moving the image reflectors 124 and 126, along with adjusting the L of the optical extender 140 to thereby adjust the length of imaging paths 134, 136, 132 and the optical focusing of corresponding circumferential sections of the perimeter band 130 on corresponding pixel sets 114, 110, 112 of the pixels of the imaging sensor 110. The adjustment of L of the optical extender 140 is illustrated in FIGS. 3 and 5 and discussed previously. Referring again to FIG. 1, the image reflectors 124, 126 may include focusing actuators 164, 166 configured to adjust the position of reflective surfaces of each image reflector 124, 126 to thereby adjust the length of the corresponding imaging paths 134, 136. The actuators 164 and 166 may move the reflective surfaces of image reflectors 124, 126 in predetermined directions, respectively, while keeping the angles of the reflective surfaces of image reflectors 124, 126 with respect to the axis of the direct view 152 unchanged in order to maintain the same optical configuration. This may not be preferable as the alignment and motion of the actuators 164 and 166 would have to be precise and complex. Furthermore, the motion may require additional space. Alternatively, the focus for the 1^{st} view 154 and 2^{nd} view 156 could be adjusted by introducing lenses in the corresponding imaging paths 134 and 136, respectively. A convex lens in the imaging path 134 may shorten it while a concave lens in the imaging path 134 may extend it. The same effect may be applied to the imaging path 136. This approach, however, will introduce additional elements into the optical configuration, which may not be desirable. Therefore, instead of moving the position of reflective surfaces of the image reflectors or adding additional lenses, reflective surfaces in image reflectors 124, 126 may be deformed into a concave or convex shape through use of actuators 164, 166. Those skilled in the art shall know that a concave reflective surface works like a convex lens and a convex reflective surface works like a concave lens. Changing the shape of a reflective surface in image reflector 124 or 126 by the actuators 164 or 166, respectively, is advantageous relative to moving the reflective surfaces or inserting lenses because it accomplishes a change in focus without adding new components into the optical configuration while keeping the necessary components nearly static.

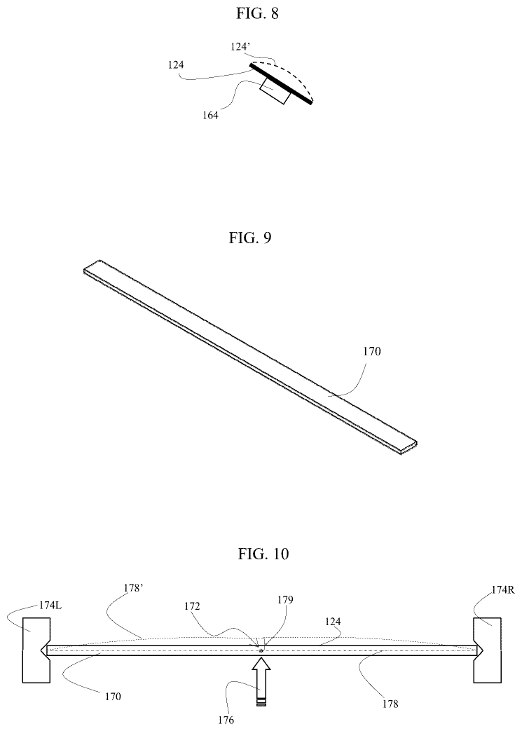

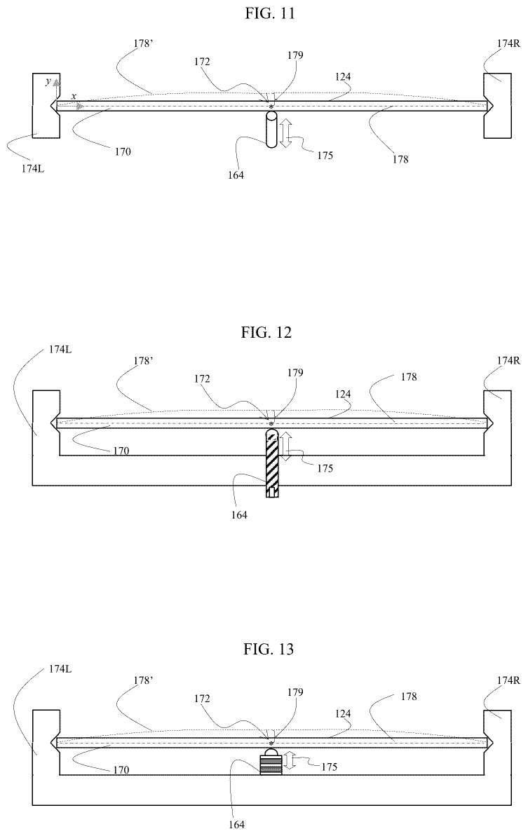

A simple bending by deflection design is presented in this invention, in which a line scan camera 100 with a linear imaging device 110 is adopted. Those skilled in the art shall know that the use of a line scan reduces the need of shape change on the reflective surfaces 124 and 126 to a two-dimensional problem; that is, a bent curve instead of a bent plane. As illustrated in FIG. 8, the reflective surface of an image reflector 124 may be shaped as 124′, substantially an arc of a circle with a known diameter, by the actuator 164 which causes an amount of deflection in the middle of the reflective surface. To accomplish this, an embodiment of bending the reflective surface 124 by a specific arrangement is adopted. In this arrangement, as shown in FIGS. 9-10, the reflective surface of the image reflector 124 is a slender, rectangular mirror 170 with uniform cross-section along its length and its length is much larger than its width and thickness (say, 10 times larger). It can be assumed that the mirror 170 is made of a uniform material such as, but not limited to glass. A coating is typically applied to one of its surfaces to form the reflective surface of the image reflector 124. In this case, the reflective coating is on top, which is known as a first surface mirror. If the mirror 170 is treated as a beam and mounted in a condition known as free-free, and a relatively small force 176 is applied to the center 172 of the mirror 170, the mirror 170 will be slightly bent or deflected, with its center line 178 becoming the curve 178′. In the case where bending of the mirror 170 is substantially small and the cross-section of the material of the mirror 170 is uniform, the curve 178′ will approximate a section of a circle with a diameter determined by the deflection 179 of the mirror 170 at its center 172. The deflection 179 is substantially small such that the deflection 179 is at or less than 0.5% of the length of the mirror 170. To accomplish the free-free mounting, the image reflectors 124, 126 may each further include a fixture defining a pair of V-shaped notches 174L and 174R configured to receive opposite sides or ends of the mirror 170. In this design, the ends of mirror 170 will have the freedom of rotating and horizontal displacement, constituting the free status. In practice, the deflection 179, instead of the force 176, will be introduced by the actuator 164, as shown in FIG. 11. The actuator 164 can form a predetermined displacement, representing the amount of deflection 179, such that the reflective surface of the image reflector 124 is deformed to a curve with a desirable diameter, obtained by calculation of beam deflection or by experiment. The contact point between the actuator 164 and the mirror 170 is preferably a convex arc. Consider the mirror 170 has a width. A suitable contact will be part of a cylindrical surface. Those skilled in the art shall know that the circle representing the deformed reflective surface 124′ can be defined by three points: (0, 0) as the left end of the mirror 170, (0.5 length of the mirror 170, deflection 179), and (length of the mirror 170, 0), assuming a Cartesian coordination system is attached to the mirror 170 in FIG. 11.

FIG. 11 illustrates a convex reflective surface deformation as the mirror 170 is pushed up. It could also be a concave reflective surface deformation if the mirror 170 is pulled down with a bonding such as suction or gluing. In practice, pushing is far easier than pulling. To accomplish bi-directional adjustment, a common practice is to set the functional neutral position of the reflective surface of the image reflector 124 in FIG. 7 to a slightly bent position. That is, with a moderate deflection 179. The functional neutral position will be the position to focus at the middle point of the varying range by the bar surface. A larger deflection 179 will extend the imaging path 134 while a smaller deflection 179 will shorten the imaging path 134.

The actuator 164 can now be something that can accomplish small displacement, such as, but not limited to, a set screw with a soft tip that extends through a threaded bore in the fixture of the image reflector 124 as illustrated in FIG. 12 or a piezoelectric displacement actuator as illustrated in FIG. 13. Those skilled in the art shall appreciate the fact that the similar deformation of the reflective surface can be accomplished by more than a single point of contact between the actuator 164 and the mirror 170. For instance, two points of contact symmetrically distributed with respect to the center 172 of the reflective surface 170 of the same amount of deflection may also result in a desirable shape. However, this is less intuitive and more complicated. This discussion of bending deflection for the reflective surface of the image reflector 124 constitutes a simple, effective, and nearly static solution to the optical configuration, and can generally be applied to the reflective surface of the image reflector 126 in the same manner with the actuator 166.

This inventive embodiment implementation as shown in FIG. 1 is advantageous in many aspects. First, only one imaging device 100 and one lens 110 are required to image the entire surface of the bar 10 as the bar 10 moves along its longitudinal axis 14. This simplifies the corresponding components to support and process the images from the imaging device. Furthermore, the images taken from all aspects are naturally synchronized in this one-imaging device configuration. Another benefit would be the ease of maintenance, particularly critical in applications where the operating environment could be harsh, such as a steel mill. The single imaging device can be placed at an orientation that is least affected by contaminants. And the reflective surfaces, typically flat mirrors, can be designed with easy replacement or automatic wiping. Those skilled in the art shall know different mechanisms for achieving the aforementioned replacement of or wiping on flat mirrors. Those skilled in the art shall appreciate that the compactness of each element, the near static nature, the effort to avoid extra components, and the simplicity of the present invention improve the practicality of the optical configuration of using one imaging device, which involves delicate spatial arrangement of several optical elements.

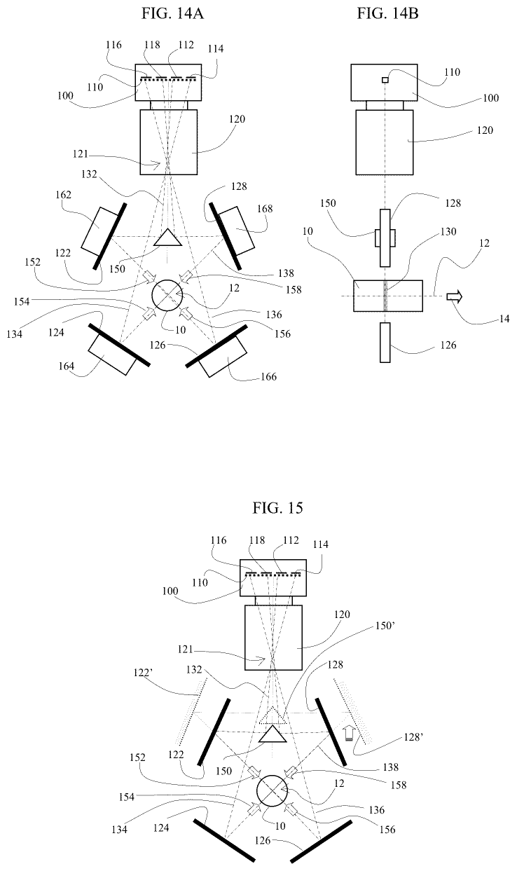

Referring now to FIGS. 14A-B for an embodiment with X=4, the present invention would involve multiple image reflectors arranged in a way such that:
(1) an imaging device 100 along with a lens 110 are selected based on the need for the optical resolution;
(2) the pixels of the linear imaging sensor 110 is divided into four different pixel sets or zones, namely, 112 (center right), 114 (far right), 116 (far left), and 118 (center left);
(3) an equal length, triangular prism 150 of a predetermined size is positioned in the field of view for the two center zones (112/118) but does not obscure the field of view for the two far side zones (114/116), and the corner formed by the two equal length edges of the prism 150 is pointing to the center of the imaging device 100, or the center of the imaging sensor 110 so that the imaging path 132, mapping from imaging sensor zone 112, is deflected by the left reflective side of this triangular prism 150 toward the image reflector 122 while the imaging path 138, mapping from imaging sensor zone 118, is deflected by the right reflective side of this triangular prism 150 toward the image reflector 128;
(4) an image reflector 122 is positioned and angled such that it receives the imaging path 132 from the triangular prism 150 and reflects the imaging path 132 toward one circumferential section of the circumferential perimeter band 130 of the bar 10, resulting in the 1^{st} view 152, which, though not necessary, would typically be 45 degrees counter clockwise from the vertical axis and pointing to the bar axis 12;
(5) an image reflector 124 is positioned and angled such that it receives the imaging path 134 from the lens 120 and reflects the imaging path 134, which maps from imaging sensor zone 114, towards another circumferential section of the circumferential perimeter band 130 of the bar 10, resulting in the 2^{nd} view 154, which, though not necessary, would typically be 135 degree counter clockwise from the vertical axis and pointing to the bar axis 12;
(6) an image reflector 126 is positioned and angled such that it receives the imaging path 136 from the lens 120 and reflects the imaging path 136, which maps from imaging sensor zone 116, towards another circumferential section of the circumferential perimeter band 130 of the bar 10, resulting in the 3^{rd} view 156, which, though not necessary, would typically be 135 degree clockwise from the vertical axis and pointing to the bar axis 12; and
(7) an image reflector 128 is positioned and angled such that it receives the imaging path 138 from the right reflective side of the triangular prism 150 and reflects the imaging path 138 towards another circumferential section of the circumferential perimeter band 130 of the bar 10, resulting in the 4^{th} view 158, which, though not necessary, would typically be 45 degrees clockwise from the vertical axis and pointing to the bar axis 12.

In this embodiment, it is known that the most intuitive, but not necessary selection would be to have the prism 150 be a right angle prism. In such a case, the reflected image paths 132 and 138 will be horizontally outward after being reflected by the prism 150. In this case, the angles for the image reflectors 122, 124, 126, and 128 will be approximately 22.5 degree from either the vertical or horizontal axis, and thus simplify the entire implementation. Also, each of the reflective surfaces of the image reflectors 122, 124, 126 and 128 can be independently adjusted by actuators 162, 164, 166, and 168, respectively for focusing.

It would be commonly known that the triangular prism 150 can be replaced by two reflective surfaces, even though the adoption of a triangular prism is convenient. It is advantageous in this embodiment to keep the image reflectors 122 and 128 in substantial symmetry, and also keep the image reflectors 124 and 126 in substantial symmetry with respect to the vertical axis centered to the imaging device 100. However, it is not absolutely necessary for a workable implementation.

The working distances for the imaging paths 134 and 136 are substantially same, while the working distances for the imaging paths 132 and 138 are substantially same, particularly if the substantial symmetry mentioned in previous paragraph is maintained. Yet, there may be a disparity between the working distances of imaging paths 132 and 134. To compensate for this in the design of the optical configuration, the set of the prism 150, the image reflector 122, and the image reflector 128, collectively the Three Optical Elements, may be moved together up (away from the object 10) or down (close to the object 10), while keeping the relationship among the Three Optical Elements (150, 122 and 128) same, except the distances between the prism 150 and the reflective surfaces 122 and 128. As illustrated in FIG. 15 (in which actuators 162, 164, 166, 168 are omitted for clarity), the Three Optical Elements are moved up to new positions shown as 150′, 122′ and 128′. Note that all three optical elements maintain the same horizontal level. The image reflectors 122′ and 128′ maintain the same angle as if they are not moved.

However, the image reflectors 122′ and 128′ will have to move outward from the prism 150 in order to maintain the ability to reflect the imaging paths 132 and 138 toward the bar axis 12. In this illustrative case, the triangle formed by the bar axis 12 and the two reflecting points on the image reflectors 122′ and 128′ is larger than the triangle formed by the bar axis 12 and the two reflecting points on the image reflectors 122 and 128. Thus, the lengths of imaging paths 132 and 138 are increased after moving the Three Optical Elements up. Conversely, if the Three Optical Elements 150, 122, and 128′ are moved down toward the object 10, the lengths of imaging paths 132 and 138 are decreased. By doing so, a skilled individual will be able to determine the exact positions of the Three Optical Elements based on balancing the lengths of imaging paths 134 and 136.

This embodiment in FIGS. 14A-B and 15 will facilitate four views, instead of three, by one imaging device 100. The ability of having four views would be advantageous for applications such as a square cross-section bar.

Those skilled in the art shall know that the image reflectors and/or the number of image reflectors can be arranged differently to accomplish the same effect of the present invention. Furthermore, those skilled in the art shall also know that it is possible to implement a two camera configuration (instead of 3 or more as specified in the Existing Patents) with the use of image reflectors. Those skilled in the art shall appreciate that the use of a line scan imaging device as the imaging device is a choice to accommodate the bar motion along its axis as well as the focusing mechanism disclosed in the present invention. However, it is also possible to use an area scan imaging device and only use limited pixels to closely simulate the effect of a line scan imaging device. Furthermore, whether the imaging device is color or black & white will depend on the need of the application and has no impact to the implementation of the present invention. Those skilled in the art will also understand that, it is not necessary to divide the pixels of the imaging sensor 110 in equal amounts for different zones. The division may depend on the actual needs from different views.

1. A system for imaging an elongated object extending and moving along its longitudinal axis, comprising:
a linear imaging device including an imaging sensor having a plurality of pixels;
a lens disposed between the linear imaging sensor and the elongated object moving along the longitudinal axis and establishing a field of view for the linear imaging device greater than a circumference of the elongated object, the lens configured to project radiation emitted by, or reflected by, a plurality of different circumferential sections of a circumferential perimeter band of the elongated object along a plurality of different imaging paths onto different pixel sets of the plurality of pixels of the imaging sensor so as to map an entirety of the circumferential perimeter band onto the plurality of pixels of the imaging sensor; and,
an adjustable first image reflector disposed in a first imaging path of the plurality of different imaging paths between the linear imaging device and a first circumferential section of the plurality of different circumferential sections of the circumferential perimeter band of the elongated object for adjusting the optical focusing of the first circumferential section on a corresponding pixel set of the plurality of pixels of the imaging sensor.

2. The system of claim 1 wherein the adjustable first image reflector includes an optical extender comprised of at least one pair of adjacent parallelogram prisms with opposite orientations and having acute angles.

3. The system of claim 2 wherein the adjacent parallelogram prisms are identical in shape and the acute angles are forty-five degrees.

4. The system of claim 2 wherein the optical extender is comprised of multiple pairs of adjacent parallelogram prisms with opposite orientations.

5. The system of claim 2 wherein each of the pair of adjacent parallelogram prisms is made from a transparent material having a refractive index of at least 1.3.

6. The system of claim 2 wherein at least one of the pair of adjacent parallelogram prisms is made from one of glass, quartz, and polycarbonate.

7. The system of claim 2 wherein at least one of the pair of adjacent parallelogram prisms defines a chamber filled with a transparent liquid.

8. The system of claim 7 wherein the liquid has a refractive index of at least 1.3.

9. The system of claim 1 wherein the adjustable first image reflector includes:
a first reflective surface; and,
a focusing actuator configured to adjust the shape of the first reflective surface by an amount of deflection in the middle of the first reflective surface.

10. The system of claim 9 wherein the adjustable first image reflector further includes a second reflective surface.

11. The system of claim 9 wherein the first reflective surface is a first surface mirror.

12. The system of claim 9 wherein the adjustable first image reflector further includes a fixture for the first reflective surface defining a threaded bore and the focusing actuator comprises a set screw configured to be received within the threaded bore.

13. The system of claim 9 wherein the focusing actuator comprises a piezoelectric displacement actuator.

14. The system of claim 9, further comprising a fixture for the first reflective surface, the fixture defining a pair of V-shaped notches configured to receive opposite sides of the first reflective surface.

15. The system of claim 9 wherein the adjustable first image reflector further includes an optical extender comprised of at least one pair of adjacent parallelogram prisms with opposite orientations.

16. The system of claim 1, further comprising an adjustable second image reflector disposed in a second imaging path of the plurality of different imaging paths between the linear imaging device and a second circumferential section of the plurality of different circumferential sections of the circumferential perimeter band of the elongated object for adjusting the optical focusing of the second circumferential section on a corresponding pixel set of the plurality of pixels of the imaging sensor.

17. The system of claim 16 wherein the adjustable first image reflector includes an optical extender comprised of at least one pair of adjacent parallelogram prisms with opposite orientations and the adjustable second image reflector includes a first reflective surface and a focusing actuator configured to adjust the shape of the first reflective surface by an amount of deflection in the middle of the first reflective surface.

18. The system of claim 16 wherein each of the adjustable first image reflector and the adjustable second image reflector includes a first reflective surface and a focusing actuator configured to adjust the shape of the first reflective surface by an amount of deflection in the middle of the first reflective surface.

19. The system of claim 1 wherein the linear imaging device is a line scan imaging device.

20. A method for imaging an elongated object extending and moving along its longitudinal axis, comprising:
positioning a linear imaging device at a radial distance from the longitudinal axis of the elongated object, the linear imaging device including an imaging sensor having a plurality of pixels;
positioning a lens between the linear imaging sensor and the elongated object moving along the longitudinal axis, the lens establishing a field of view for the linear imaging device greater than a circumference of the elongated object, the lens configured to project radiation emitted by, or reflected by, a plurality of different circumferential sections of a circumferential perimeter band of the elongated object along a plurality of different imaging paths onto different pixel sets of the plurality of pixels of the imaging sensor so as to map an entirety of the circumferential perimeter band onto the plurality of pixels of the imaging sensor;
positioning an adjustable first image reflector in a first imaging path of the plurality of different imaging paths between the linear imaging device and a first circumferential section of the plurality of different circumferential sections of the circumferential perimeter band of the elongated object; and,
adjusting the adjustable first image reflector to adjust optical focusing of the first circumferential section on a corresponding pixel set of the plurality of pixels of the imaging sensor.
